(19) United States
(12) Patent Application Publication
(10) Pub. No.: US 2026/0370458 A1
(43) Pub. Date: Nov. 19, 2026

(54) SYSTEMS AND METHODS FOR ROUND-EFFICIENT AUTHENTICATED KEY EXCHANGE AND CLIENT AUTHENTICATION

(71) Applicant: JPMORGAN CHASE BANK, N.A., New York, NY (US)

(72) Inventors: Wenyu KON, Singapore (SG); Kaushik CHAKRABORTY, Singapore (SG); Charles LIM, Singapore (SG); Marco PISTOIA, Amawalk, NY (US)

(21) Appl. No.: 18/637,027

(22) Filed: Apr. 16, 2024

(51) Int. Cl. H04L 9/08; H04L 9/32

(52) U.S. Cl. CPC H04L 9/0852; H04L 9/085; H04L 9/3242

(57) ABSTRACT

A method may include: a first party and a second party sharing a set of identification keys, an authentication key, and a one-time pad (OTP) key; the first party and the second party selecting a first party key label or a second party key label; the second party preparing quantum systems and sending the quantum systems to the first party; the first party measuring the quantum systems and announcing the quantum systems with detected photons; the first party generating a first party tag using measured bit values from the quantum systems; the first party forwarding the first party tag to the second party; the second party validating the first party using the first party tag; the second party generating a second party tag using the randomly chosen bit values from the quantum systems; and the first party validating the second party using the second party tag.

### BACKGROUND OF THE INVENTION

### 1. Field of the Invention

Embodiments relate to systems and methods for round-efficient authenticated key exchange and client authentication.

### 2. Description of the Related Art

Authenticated key exchange (AKE) is an important cryptography primitive that is critical to securing digital infrastructures from the rising threat of quantum computers. Client authentication (CA) is similarly an important cryptography primitive, where it allows for a valid client to be authenticated, ensuring that no secrets are leaked to unauthorized personnel. With a quantum-based CA, it is possible to achieve key refreshing, thereby allowing the authentication to repeat without slowly compromising the secret shared by the client and server.

### SUMMARY OF THE INVENTION

Systems and methods for round-efficient authenticated key exchange and client authentication are disclosed. In one embodiment, a method may include: (1) sharing, by a first party computer program and a second party computer program, a set of identification keys, an authentication key, and a one-time pad (OTP) key; (2) selecting, by the first party computer program and the second party computer program, a first party key label or a second party key label; (3) preparing, by the second party computer program, quantum systems using a basis, randomly chosen bit values, and intensities; (4) sending, by the second party computer program, the quantum systems to the first party computer program over a quantum communication channel; (5) measuring, by the first party computer program, the quantum systems using the basis and announcing the quantum systems with detected photons; (6) generating, by the first party computer program, a first party tag using a shared keyed hash function executed on the authentication key, the OTP key, and the measured bit values from the quantum systems; (7) forwarding, by the first party computer system, the first party tag to the second party computer program; (8) validating, by the second party computer program, the first party using the first party tag; (9) generating, by the second party computer program, a second party tag using the shared keyed hash function executed on the authentication key, the OTP key, and the randomly chosen bit values from the quantum systems; and (10) validating, by the first party computer program, the second party using the second party tag.

In one embodiment, the second party computer program validates the first party by: generating a first party validation tag using the shared keyed hash function executed on the authentication key, the OTP key, and measurement outcomes for the randomly chosen bit values; and comparing the first party tag to the first party validation tag, wherein the first party is validated in response to the first party tag matching the first party validation tag.

In one embodiment, the basis may be generated using a key expansion algorithm.

In one embodiment, the method may also include: sharing, by the first party computer program and the second party computer program, a privacy amplification seed; and performing, by the first party computer program with the second party computer program, privacy amplification to generate a shared secret bitstring and update the identification key associated with the selected key label.

In one embodiment, the method may also include selecting, by the first party computer program with the second party computer program, a new identification key in response to a failure.

In one embodiment, the measurement outcomes for the randomly chosen bit values may be corrected using error correction to match the measurement outcomes.

In one embodiment, the method may also include sending, by the first party computer program a syndrome, wherein the second party computer program performs the error correction using the syndrome.

In one embodiment, the method may also include: estimating, by the second party computer program, a number of multi-photon events in the quantum systems with photon detection based on the announcement of the quantum systems in a test set and an intensity for each of the quantum systems.

In one embodiment, the second party computer program declares failure in response to the number of multi-photon events in the quantum systems in a key generation set being above a threshold.

In one embodiment, the second party computer program selects the intensity using a random number generator.

According to another embodiment, a method may include: (1) sharing, by a server computer program executed by a server and a client computer program for a client, a set of identification keys, and a one-time pad (OTP) key; (2) selecting, by the client computer program and the server computer program, a client key label or a server key label; (3) preparing, by the server computer program, quantum systems using a basis, randomly chosen bit values, and intensities; (4) sending, by the server computer program, the quantum systems to the client computer program over a quantum communication channel; (5) sending, by the server computer program, a server tag and a server key label to the client computer program; (6) measuring, by the client computer program, the quantum systems using the basis; (7) validating, by the client computer program, the server by comparing the server tag to a server tag generated by the client computer program in a prior interaction with the server; (8) generating, by the client computer program, a client tag using a shared keyed hash function executed on an authentication key and measured bit values from the quantum systems with photon detection; (9) receiving, by the server computer program, the client tag; and (10) validating, by the server computer program, the client using the client tag.

In one embodiment, the client computer program further validates the server by: receiving, by the client computer program and from the server computer program, a server label and a server tag; and comparing, by the client computer program, the server label and server tag received from the server computer program to a client label and a stored server label stored by the client computer program.

In one embodiment, the server computer program validates the client computer program by: generating, by the server computer program, a client validation tag using the shared keyed hash function executed on the authentication key, the OTP key, and the randomly chosen bit values; and comparing, by the server computer program, the client tag to the client validation tag, wherein the client is validated in response to the client tag matching the client validation tag.

In one embodiment, the method may also include: sharing, by the client computer program and the server computer program, a privacy amplification seed; and performing, by the server computer program and the client computer program, privacy amplification to update an identification key associated with the selected key label and generate server tags.

According to another embodiment, a method may include: (1) sharing, by a server computer program and separately with a plurality of client computer programs, each client computer program associated with a client, sets of identification keys, a set of one-time pad (OTP) key, and an authentication key; (2) detecting, by the server computer program, a client electronic device executing the client computer program associated with one of the clients; (3) preparing, by the server computer program, a plurality of quantum system for the plurality of clients; (4) sending, by the server computer program, a server key label to the client computer program; (5) sending, by the server computer program, the plurality of quantum systems to the client computer program over a quantum communication channel; (6) measuring, by the client computer program, the quantum systems using a basis; (7) validating, by the client computer program, the server by comparing a server tag to a server tag generated by the client computer program in a prior interaction with the server; (8) generating, by the client computer program, a client tag using a shared keyed hash function executed on the authentication key, the OTP key, and measured bit values from the quantum systems with photon detection; (9) receiving, by the server computer program, the client tag and the client key label; and (10) validating, by the server computer program, the client using the client tag.

In one embodiment, the client computer program further validates the server by: receiving, by the client computer program and from the server computer program, a server label and a server tag; and comparing, by the client computer program, the server label and server tag received from the server computer program to a client label and a stored server label stored by the client computer program.

In one embodiment, the server computer program validates the client computer program by: generating, by the server computer program, a client validation tag using the shared keyed hash function executed on the authentication key, the OTP key, and randomly chosen bit values; and comparing, by the server computer program, the client tag to the client validation tag, wherein the client may be validated in response to the client tag matching the client validation tag.

In one embodiment, the method may also include: sharing, by the client computer program and the server computer program, a privacy amplification seed; and performing, by the server computer program and the client computer program, privacy amplification to update the identification key associated with the key label and generate server tags.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for round-efficient authenticated key exchange according to an embodiment;

FIGS. 2A, 2B, and 2C illustrate a method for round-efficient authenticated key exchange according to an embodiment;

FIG. 3 illustrates a system for round-efficient client authentication according to another embodiment;

FIGS. 4A, 4B, and 4C illustrate a method for round-efficient client authentication according to another embodiment;

FIG. 5 depicts an exemplary computing system for implementing aspects of the present disclosure.

### DETAILED DESCRIPTION OF PREFERRED EMBODIMENTS

Embodiments relate to systems and methods for round-efficient authenticated key exchange and client authentication.

The disclosure of U.S. patent application Ser. No. 18/348,865 is hereby incorporated, by reference, in its entirety.

Embodiments are directed to a round-efficient AKE protocol that provides a combination of features that are not present in other related protocols, including information-theoretic security, no sifting, and resistance to practical imperfections. For example, embodiments are not based on any computational hardness assumption and thus provides everlasting security, unlike classical authenticated key exchange protocols. Embodiments pre-share basis information, thereby allowing for the basis selection to always match, removing the need for basis sifting which could induce a penalty in other quantum key distribution (QKD) protocols. This also reduces the number of communication rounds due to the removal of basis communication. Embodiments are also resistant to practical imperfections, namely signal loss, channel noise, and the presence of multi-photon events. Thus, embodiments may operate in the presence of such imperfections, as long as they are within a certain tolerable range.

Multi-photon events are events where one party sends multiple photons in a quantum system and the receiving party registers a photon detection. The number of photons detected by the receiving party may be a single photon, even though multiple photons are sent, due to signal loss.

In embodiments, the round-efficient CA protocol, a client may be authenticated by a server. The proposed round efficient protocol provides information-theoretic security and a low number of communication rounds, while allowing for the authentication keys to be re-used.

Compared to known CA protocols, embodiments may switch the quantum source and detector position, along with a grouping of communication rounds, thereby reducing the total number of communication rounds and thereby improving its efficiency.

Embodiments may remove the requirement for a secure broadcast channel between the client and server, which makes the protocol more realistic and efficient.

Embodiments may require only a single challenge from the server, followed by a response from the client, i.e., only two rounds of communication are needed.

Embodiments may provide key recycling, so that secrets are only updated if the protocol fails. This eliminates the need for frequent update of secrets.

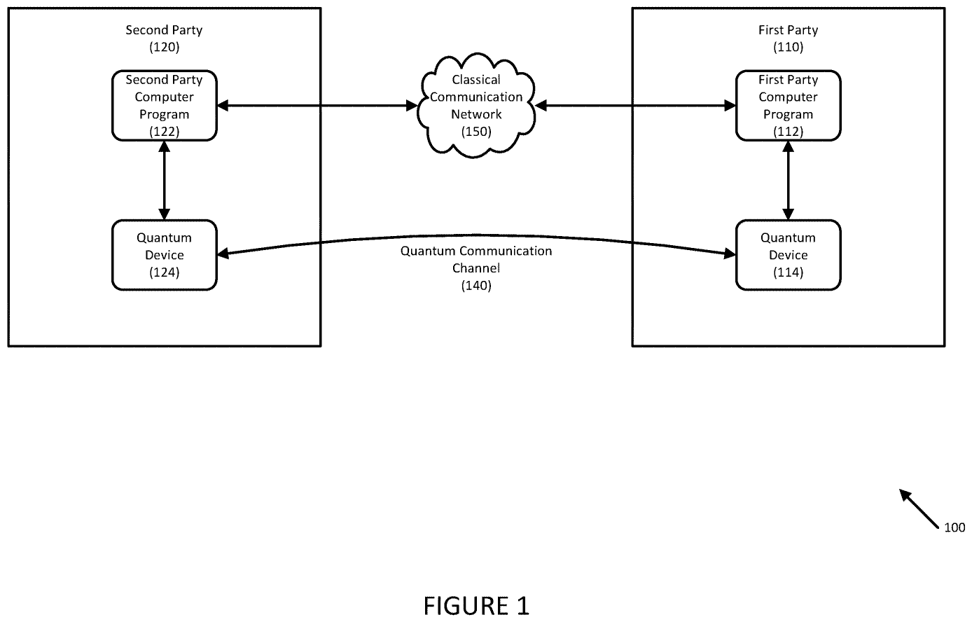

Referring to FIG. 1, a system for round-efficient authenticated key exchange and client authentication is disclosed according to an embodiment. System 100 may include first party 110 and second party 120. First party 110 may execute first party computer program 112 on an electronic device (not shown) that may include quantum device 114.

Second party 120 may execute second party computer program 122 on an electronic device (not shown) that may include quantum device 124.

Examples of quantum devices 114 and 124 may include a laser source with a modulator (e.g., for second party 120), and a photodetector with beam splitters (e.g., for first party 110). Other types of devices may be used as is necessary and/or desired. Quantum devices 114 and 124 may communicate quantum information with each other using quantum communication channel 140, such as a direct optical fiber link. The quantum data may be communicated as photons.

First party computer program 112 and second party computer program 122 may communicate with each other over classical communication network 150, which may include classical communication channels, such as optical fiber links, ethernet, the Internet, etc. First party computer program 112 and second party computer program 122 may execute protocols for secure client authentication and secure authenticated key exchange.

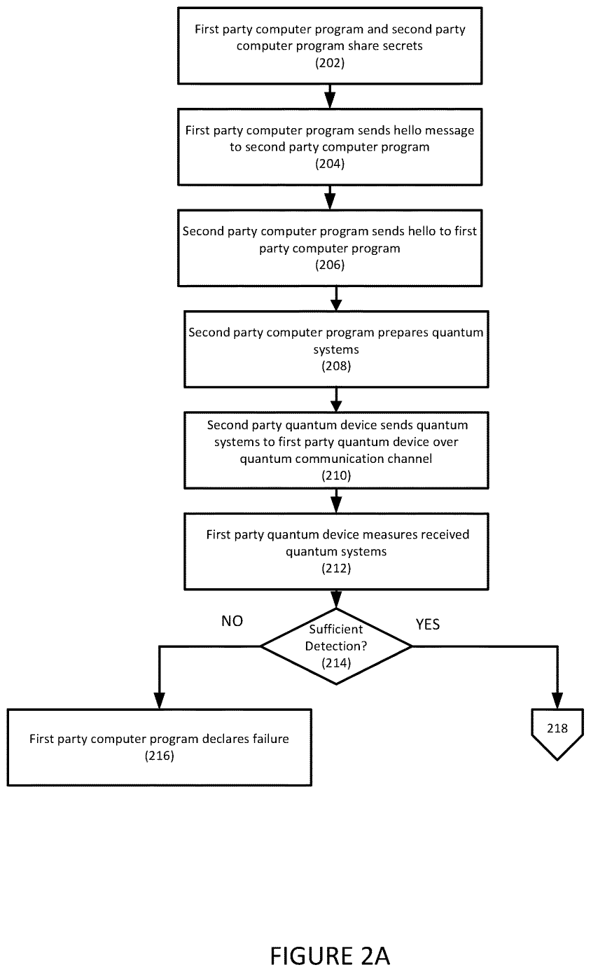

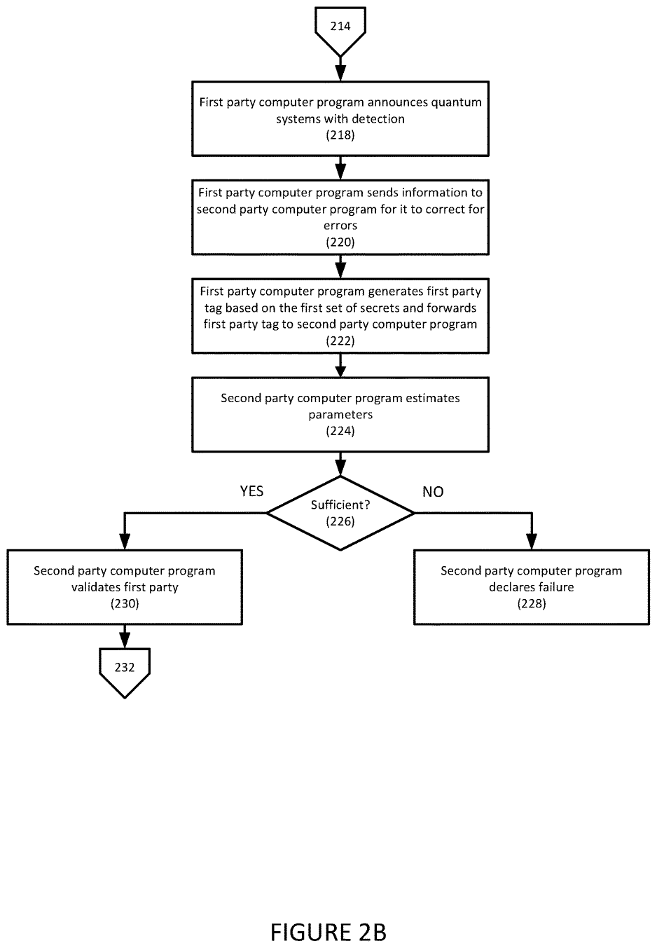

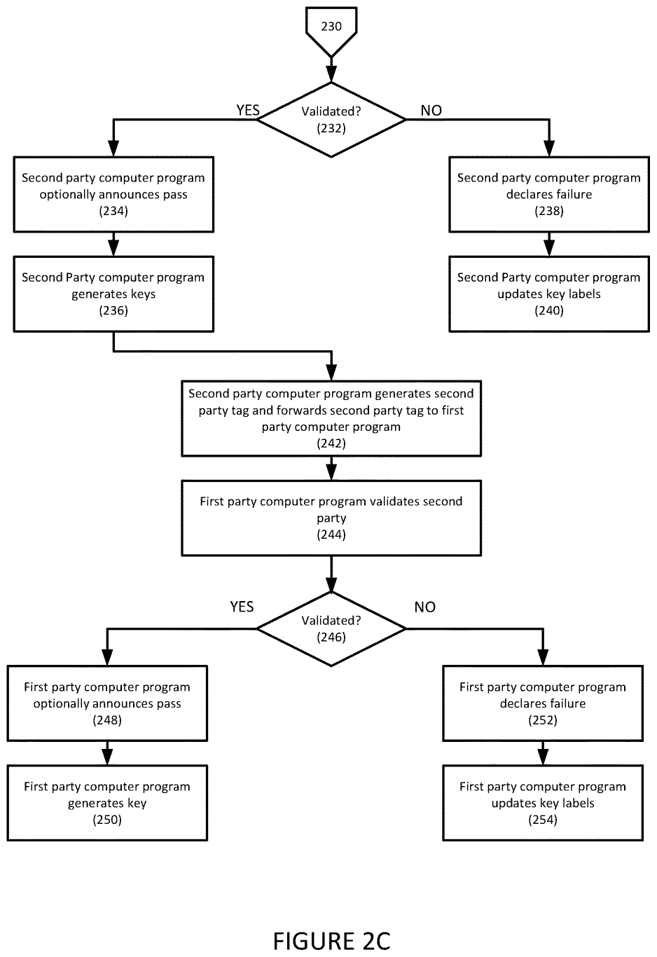

Referring to FIGS. 2A and 2B, a method for round-efficient authenticated key exchange is disclosed according to an embodiment.

In step 202, a first party computer program and a second party computer program may share secrets, such as bitstrings. For example, the first party computer program and the client may share several secrets: a set of identification keys θ, two authentication keys

$${K}_{1}^{h}$$

and K₂, a set of One-Time Pad (OTP) keys φ, and a privacy amplification seed r. Identification keys θ may include a set of m secrets {θ¹, θ², . . . , θ^{m}} that are labeled by index i, where i=1, 2, . . . , m. The length of each identification key θⁱ may be small compared to the length of authentication key

$${K}_{1}^{h} .$$

Each identification key θⁱ may be d-bit random string, i.e., θⁱ ∈{0, 1}^{d}.

OTP keys φ may include a set of m secrets {φ¹, . . . , φ^{m}}. The length of each OTP key may be small compared to the length of authentication key

$${K}_{1}^{h} .$$

The authentication key K₂ may have two components, e.g.,

$${K}_{2}^{h} and {K}_{2}^{OTP} .$$

The key pairs

$$( {K}_{1}^{h} , {φ}^{i} ) and ( {K}_{2}^{h} , {K}_{2}^{OTP} )$$

may be seeds to a keyed hash function H. For example, H may be a family of almost-strongly two-universal hash functions.

Privacy amplification seed r may be a member of a set of random numbers, R, and may be used for privacy amplification—a process of generating secret keys from a bitstring that is only partially secret. Privacy amplification may be used for key generation and key updating. Privacy amplification seed may be a random seed to a quantum-proof strong extractor EXT, which may be a family of functions. For example, EXT may be a family of two-universal hash functions.

In one embodiment, the first party computer program and the second party computer program may be pre-shared with identification keys θ, two authentication keys

$${K}_{1}^{h}$$

and K₂, a set of OTP keys φ, and a privacy amplification seed r.

In one embodiment, the sharing of secrets may only be performed one time. Following the sharing, the protocol may be executed many times (e.g., after the secrets are shared, each time the first party and the second party want to generate a new secret key, the protocol may start with step 204).

The first party and second party may hold key labels γ and γ′ respectively, which are used to keep track of the identification key θ^{γ} and the OTP key φ^{γ} to use for basis choice in each iteration of the protocol. Key labels γ and γ′ may be public information.

As used herein, “round” refers to the preparing, sending and measurement of one quantum system. For example, embodiments may prepare, send, and measure n quantum systems Q₁ to Qₙ, so there are a total of n quantum systems, or “rounds.” The quantum systems may be tracked by their index i.

A “quantum system” refers to the physical carriers of quantum information. Examples of physical carriers include photons that are sent between quantum devices.

The first party and second party may also share a keyed hash function H(a∥b, x) (where the key is (a, b)∈

$$\{ ( {K}_{1}^{h} , {φ}^{i} ) and ( {K}_{2}^{h} , {K}_{2}^{OTP} ) \}$$

to generate an l-bit tag for authentication, and a quantum-proof strong extractor EXT (r, x′) with seed r, to update the identification key and generate the secret keys at the end of each iteration of the protocol. A “tag” may be a bitstring.

In step 204, the first party computer program may send a hello message to the second party computer program that may include an identity claim and a first party key label γ.

In step 206, the second party computer program may send a hello message to the first party computer program that may include an identity claim and a second party key label γ′. Both the first party computer program and the second party computer program may select the key label j=max [γ, γ′]. The first party computer program and second party computer program may also update their key labels γ=j and γ′=j, noting that the identification keys θ and the OTP keys φ for indices less than j have been compromised based on the other party's records.

In step 208, the second party computer program may prepare quantum systems. For example, the second party computer program may generate n quantum systems using the information from the basis generated from the identification key θ^{γ} (using the agreed-upon key label γ), the randomly chosen bit values x, and intensities.

In one embodiment, the randomly chosen bit values may be generated by the second party computer program using a random number generator or similar.

In one embodiment, the second party computer program may select the intensities using a random number generator before it prepares the quantum systems. For example, the second party computer program may randomly choose these intensities from a set of three or more possible intensities.

The second party computer program may optionally use a key expansion algorithm to create a longer bit string of size n from the d-bit identification key θ^{γ}. For example, the key expansion algorithm, such as AES, may take a short random string, such as θ^{γ}, and may expand it to a longer bit string, such as \tilde{θ}. The longer bit string, \tilde{θ}, may be the basis used by the second party computer program.

The key expansion algorithm may be used if the identification key that was shared is short, but the parties require a longer bit string for the basis (e.g., due to memory constraints).

In one embodiment, the second party computer program may generate a random n-bit string x, select three intensity values μ₁, μ₂, μ₃, and generate a n-ternary digit (“trit”) string v. The second party computer program may instruct the quantum device to generate n quantum systems, Q₁, . . . , Qₙ. Each quantum system may be prepared in a phase-randomized coherent state (e.g., following a quantum key distribution scheme, such as BB84) with basis \tilde{θ}, bit value x, and intensity μᵥ.

In step 210, the second party computer program may send the quantum states to the first party computer program over a quantum communication channel. For example, the second party quantum device may send the n quantum systems Q₁, . . . , Qₙ to the first party quantum device. Due to the channel loss, some of the quantum systems may be lost.

In step 212, the first party quantum device may measure the received quantum systems. The measurement may detect the presence of photons in the quantum systems, and may also give information on the state of the photons depending on the basis. In one embodiment, the first party computer program may use the same key expansion algorithm to create a longer bit string \tilde{θ} of size n from the d-bit identification key θ^{γ}. Then, in each round, the first party computer program may instruct the quantum device to measure quantum system Qᵢ using i^{th} bit of the longer bit string \tilde{θ}ᵢ, and may record outcome x′ᵢ based on the detection. If the second party computer program detects no photons, it may declare the round to have a no photon detection event and may set x′ᵢ to a value other than 0 or 1. If the first party computer program detects other inconclusive outcomes, it may randomly select x′ᵢ∈{0, 1}. The first party computer program may record the set S to contain the indices of quantum systems where there is a detection, i.e., quantum systems that are not declared as a no photon detection event.

If, in step 214, there are an insufficient number of quantum systems with detection, e.g., if |S|<Sₜₕ for some threshold Sₜₕ, then the first party computer program may set D_{det}=0, and in step 216, the first party computer program may declare a failure by sending random messages to the second computer program.

In step 214, if there are sufficiently many quantum systems where there is a detection (i.e., there are sufficiently many quantum systems in set S) the first party computer program may set D_{det}=1, and in step 218, the first party computer program may announce quantum systems with detection, i.e., the set S. The first party computer program may split the set S into two sub-sets S₁ and S₂ based on some pre-determined ratio, and announce the set S₁ and the bit values in the set,

$${x}_{{S}_{1}}^{′} .$$

In step 220, to avoid the impact of the channel noise, the first party computer program and the second party computer program may perform classical error correction. For example, the first party computer program may provide information for the second party computer program to correct its measurement outcomes x′ to match the chosen bit values x of the detected quantum systems.

In one embodiment, the first party computer program may generate a syndrome

$${P}_{C} ( {x}_{{S}_{2}}^{′} , {e}_{tol} ) ,$$

based on the tolerated error rate eₜₒₗ and may send this syndrome to the second party computer program. The second party computer program may use the syndrome to correct its chosen bit values,

$${\hat{x}}_{{S}_{2}}^{′} = {f}_{P} ( {P}_{C} , {x}_{{S}_{2}} ) .$$

The syndrome is used to provide information to the second party computer to correct for errors in its bitstring.

In step 222, the first party computer program may generate and forward a first party tag to second party computer program. In one embodiment, the first party computer program may generate the first party tag based on the Authentication key

$${K}_{1}^{h} ,$$

OTP key φ^{γ}, some messages, and measurement outcomes x′ of the detected quantum systems. The first party computer program may use a shared keyed hash function H to generate the first party tag. For example, the first party computer program may generate first party tag

$${t}_{AV} = H ( {K}_{1}^{h} \vert \vert {φ}^{γ} , {\hat{x}}_{{S}_{1}}^{′} \vert \vert {\hat{x}}_{{S}_{2}}^{′} \vert \vert {S}_{1} \vert \vert {S}_{2} \vert \vert {P}_{C} )$$

and may forward the first party tag to the second party computer program. The shared keyed hash function may be the same keyed hash function described above.

In step 224, the second party computer program may estimate parameters. Based on the detection announcement and choice of intensity, the second party computer program may estimate the number of multi-photon events (e.g., events in which multiple photons are sent by the second party quantum device and detected by the first party quantum device) in the detected quantum systems. If, in step 226, the estimated number exceeds a certain threshold, the parameter estimation fails, and in step 228, the second party computer program may declare a failure decision.

For example, the second party computer program may compute an estimate of the multi-photon events in these sets, based on the number of detected quantum systems in set S for each given intensity choice. If the estimated number of multi-photon events exceeds a tolerance value, in step 228, the second party computer program may declare that the protocol has failed, and may set D_{PE}=0. Otherwise, the second party computer program may set D_{PE}=1.

In step 230, the second party computer program may validate the first party. The second party computer program may generate a first party validation tag using the authentication key

$${K}_{1}^{h} ,$$

OTP key φ^{γ′}, and the corrected measurement outcome of the detected quantum systems.

In step 232, the second party computer program may compute a first party validation tag

$${\tilde{t}}_{AV} = H ( {K}_{1}^{h} \vert \vert {φ}^{{γ}^{′}} , {\hat{x}}_{{S}_{2}}^{′} \vert \vert {\hat{x}}_{{S}_{2}}^{′} \vert \vert {S}_{1} \vert \vert {S}_{2} \vert \vert {P}_{C} )$$

and may check to see if the first party tag t_{AV} matches the first party validation tag \tilde{t}_{AV}. If the tags match, the second party computer program may validate the first party and, in step 234, may optionally announce that the validation passed and may output D_{AV}=1.

If the tags do not match, in step 238, the second party computer program may declare a failure, and may set D_{AV}=0.

In step 236, the second party computer program may perform privacy amplification to generate secret keys and update the identification key

$${θ}^{{′γ}^{′}} \vert \vert {ω}^{′} = EXT ( r , {\hat{x}}_{{S}_{2}}^{′} ) .$$

In step 240, the second party computer program may update the key labels by setting γ′=γ′+1. If γ′>m, the second party computer program may announce to abort the protocol entirely.

In step 242, the second party computer program may generate a second party tag based on the second authentication key and may forward the second party tag to the first party computer program. For example, the second party computer program may generate second party tag

$${t}_{BV} = H ( {K}_{2}^{h} \vert \vert {K}_{2}^{OTP} , {\hat{x}}_{{S}_{2}}^{′} )$$

and may forward the second party tag to the first party computer program.

In step 244, the first party computer program may validate the second party using the second party tag. For example, the first party computer program may compute a second party validation tag

$${\tilde{t}}_{BV} = H ( {K}_{2}^{h} \vert \vert {K}_{2}^{O T P} , {\hat{x}}_{{S}_{2}}^{′} )$$

and may check to see if second party tag tpv matches the second party validation tag \tilde{t}_{BV}. If, in step 246, the tags match, in step 248, the first party computer program may validate the second party and may output D_{BV}=1.

In step 250, the first party computer program may perform privacy amplification to generate secret keys ω and update the identification key θ^{γ} using the extractor EXT with seed r, and having the measurement outcomes as inputs.

For example, if the protocol is declared as a success by the first party, (i.e., D_{BV}=1 and D_{det}=1), the first party computer program may perform privacy amplification to generate secret keys and update the identification key

$${θ}^{γ} \vert \vert ω = EXT ( r , {x}_{{S}_{2}}^{′} ) .$$

If the second party's updated identification key θ′^{γ′} is mismatched with the first party's updated identification key θ^{γ}, the second party may continue using its updated identification key θ′^{γ′} in future iterations of the protocol.

If the protocol is declared as a failure, in step 252, the first party computer program may declare a failure.

In step 254, the protocol is declared as a failure by the first party computer program (i.e., D_{BV}=0 or D_{det}=0), and the first party computer program may update the key labels by setting γ=γ+1.

If γ>m, the first party computer program may announce to abort the protocol entirely.

If either the first or second party computer program announce to abort the protocol entirely, both the first party computer program and the second party computer program may refresh their shared secrets through external means.

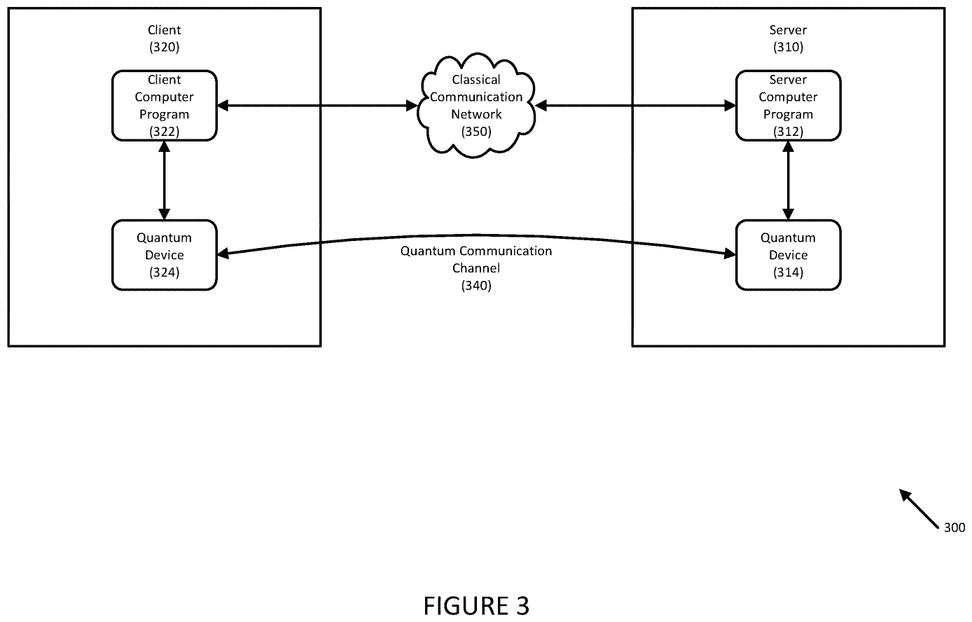

Referring to FIG. 3, a system for round-efficient client authentication is according to another embodiment.

System 300 may include server 310 and client 320. Server 310 may be any suitable server, including physical and/or cloud-based server. Server 310 may execute server computer program 312 and may include quantum device 314.

Client 320 may be any suitable electronic device, including computers (e.g., workstations, desktops, laptops, notebooks, laptops, tablets, etc.), smart devices (e.g., smart phones, smart watches, etc.), Internet of Things (IoT) devices, etc. Client 320 may execute client computer program 322 and may include quantum device 324.

Examples of quantum devices 314 and 324 may include a laser source with a modulator (e.g., for server 330), and a photodetector with beam splitters (e.g., for client 320). Other types of devices may be used as is necessary and/or desired. Quantum devices 314 and 324 may communicate quantum information with each other using quantum communication channel 340, such as a direct optical fiber link. The quantum data may be communicated as photons.

Server computer program 312 and client computer program 322 may communicate with each other over classical communication network 350, which may include classical communication channels, such as optical fiber links, Ethernet, the Internet, etc. Server computer program 312 and client computer program 322 may execute protocols for secure client authentication.

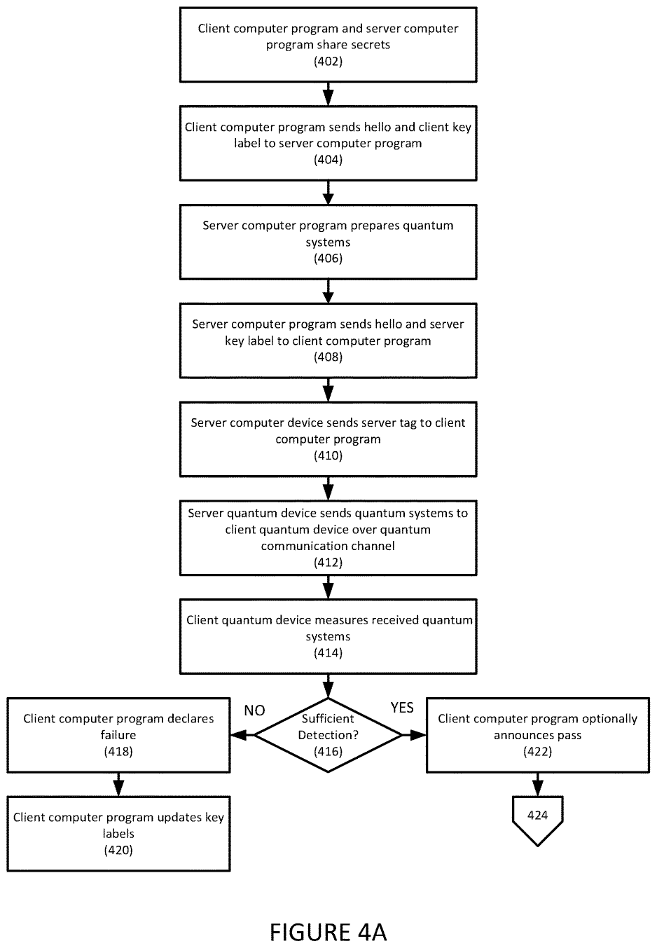

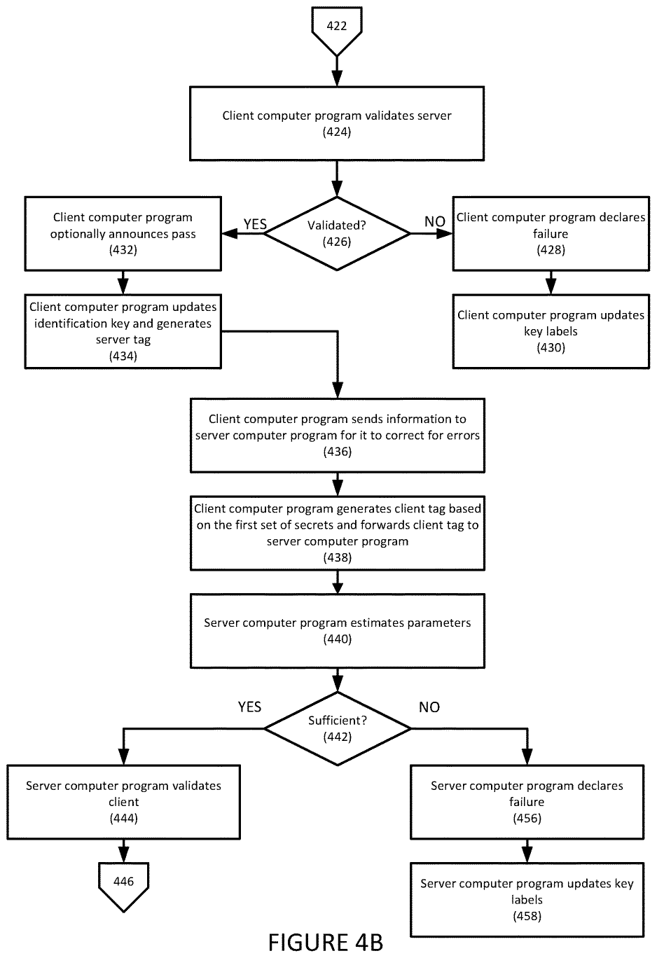

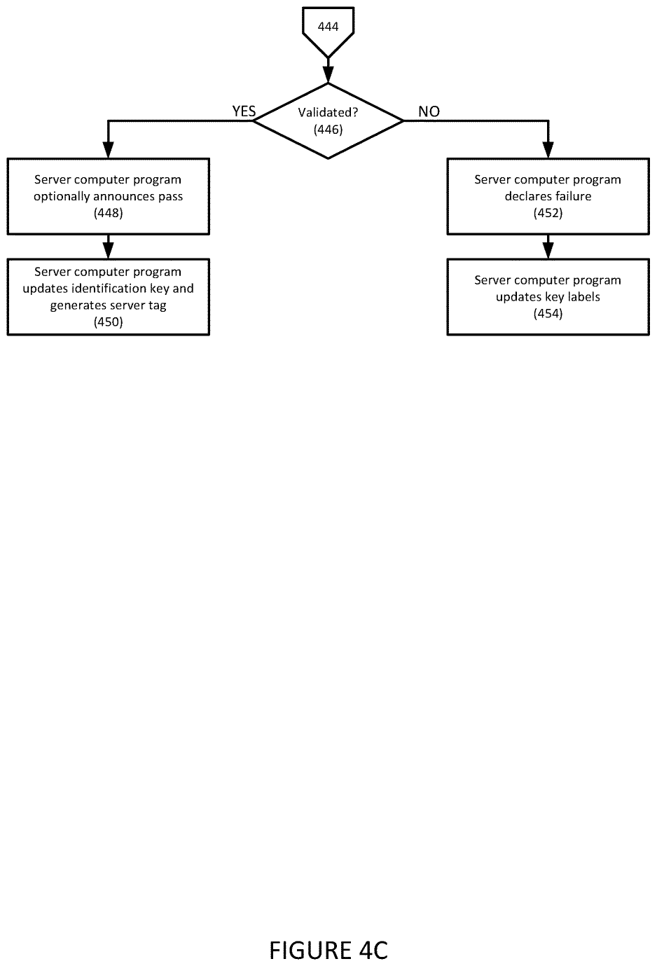

Referring to FIGS. 4A-4C, a method for round-efficient client authentication is disclosed according to another embodiment. In this embodiment, instead of there being two parties that are untrusted, a server and a client are involved.

In step 402, a client computer program and server computer program may share secrets. This may be similar to step 202.

In one embodiment, the sharing of secrets may only be performed one time. Following the sharing, the protocol may be executed many times (e.g., after the secrets are shared, each time a client approaches a server electronic device, such as an automated teller machine, the protocol may start with step 404).

In step 404, the client computer program may send a hello and a client key label to the server computer program. This may be similar to step 204.

In step 406, the server computer program may prepare quantum systems. This may be similar to step 208.

In step 408, the server computer program may send a hello and a server key label to the client computer program.

In step 410, the server computer program may retrieve an encrypted server tag from a prior interaction with the client and may send it to the client computer program. For example, the server computer program may identify the client from the client identity claimed in the client hello, and may use that to retrieve the encrypted server tag T_{SV}′ for the prior interaction with the client.

In step 412, the server quantum device may send the quantum systems to the client quantum device over a quantum communication channel. This may be similar to step 210.

In step 414, the client quantum device may measure the received quantum systems. This may be similar to step 212.

In step 416, the client computer program may determine if there is sufficient detection. If there is not, in step 418, the client computer program may declare a failure. This may be similar to step 216.

In step 420, the client computer program may update key labels.

If there is sufficient detection, in step 422, the client computer program may optionally announce pass.

In step 424, the client computer program may validate the server.

In step 426, the client computer program may compare the server label γ′ it received and its client label γ. If the received server label is larger than the client label, the client computer program may validate the server. If the received server label matches the client label, the client computer program may retrieve the encrypted server tag T_{SV} from its memory and compare it with the received encrypted server tag

$${T}_{SV}^{′} .$$

If the tags match, the client computer program may validate the server. If the client computer program validates the server, in step 432, the client computer program may optionally announce that the validation passed and may output D_{SV}=1.

If the received server label is smaller than the client label, or if the encrypted server tag T_{SV} does not match the received encrypted server tag

$${T}_{SV}^{′}$$

when the server label and client label are equal, in step 430, the client computer program may declare a failure, and may set D_{SV}=0.

In step 434, the client computer program may perform privacy amplification to update the identification key and generate a server tag, θ^{γ}∥

$${\tilde{T}}_{SV} = EXT ( r , {\hat{x}}_{{S}_{2}}^{′} ) .$$

In one embodiment, the client computer program may further secure the server tag by encrypting it such that T_{SV}=\tilde{T}_{SV}⊕K₂. The client computer program may store the encrypted server tag T_{SV} in its memory.

In step 430, the client computer program may update the key labels by setting γ=γ+1. In addition, the client computer program may store the encrypted server tag T_{SV} as a bit string of all zeros in its memory.

If γ>m, the client computer program may announce to abort the protocol entirely.

In step 436, the client computer program may send information to the server computer program for it to correct for errors. This may be similar to step 220.

In step 438, the client computer program may generate a client tag based on the first set of secrets and may forward the client tag to the server computer program. This may be similar to step 222.

In step 440 the server computer program may estimate parameters. This may be similar to step 224.

If, in step 442, the parameters are sufficient, in step 444, the server computer program may validate the client. This may be similar to step 230.

If, in step 446, the client is validated, in step 448, the server computer program may optionally announce pass.

In step 450, the server computer program may perform privacy amplification to update the identification key and generate a server tag,

$${θ}^{{′γ}^{′}} \vert \vert {\tilde{T}}_{SV}^{′} = EXT ( r , ) .$$

The server computer program may encrypt the server tag,

$${T}_{SV}^{′} = {\tilde{T}}_{SV}^{′} ⊕ {K}_{2} .$$

The server computer program may store the encrypted server tag into its memory.

If the client is not validated, in step 452, the server computer program may declare a failure, and in step 454, may update its key labels by setting γ′=γ′+1.

In one embodiment the server computer program may store the encrypted server tag

$${T}_{SV}^{′}$$

as a bit string of all zeros in its memory.

If, in step 442, the parameters are not sufficient, in step 456, the server computer program may declare failure, and in step 458, may update the key labels. This may be similar to step 454.

In another embodiment, the protocol described in FIGS. 4A-4C may proceed without the client computer program initiating the protocol by sending a client hello. Instead, the server computer program may detect the client device (e.g., by the client providing the token to the server), and upon detection, may prepare the quantum systems as described in step 406.

In this embodiment, the client sends its key label to between steps 438 and 440. Since the server computer program does not know the client's claimed identity while preparing the quantum system and server tag in steps 406 and step 410, the server computer program has to prepare one set of quantum system and one server tag for each possible client (e.g., a set of quantum systems and server tag for client 1 that client 1 can verify, a second set for client 2, etc., up to the total number of possible valid clients). The client computer program, in step 414 and 426, uses the set of quantum systems and server tag that matches its identity (e.g., if the client is client 7, it would use the 7th set of quantum system and 7th server tag).

Further, in step 444, an additional check of the client label γ received and its server label γ′ may be performed. If the client label received is larger than the server label, the server computer program updates the server label as γ′=γ−1 and declares a failure in step 452.

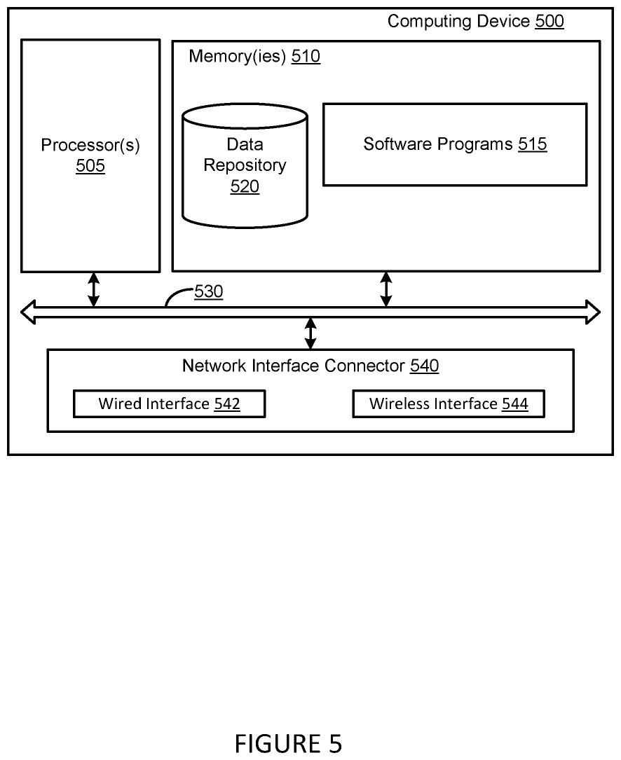

FIG. 5 depicts an exemplary computing system for implementing aspects of the present disclosure. FIG. 5 depicts exemplary computing device 500. Computing device 500 may represent the system components described herein. Computing device 500 may include processor 505 that may be coupled to memory 510. Memory 510 may include volatile memory. Processor 505 may execute computer-executable program code stored in memory 510, such as software programs 515. Software programs 515 may include one or more of the logical steps disclosed herein as a programmatic instruction, which may be executed by processor 505. Memory 510 may also include data repository 520, which may be nonvolatile memory for data persistence. Processor 505 and memory 510 may be coupled by bus 530. Bus 530 may also be coupled to one or more network interface connectors 540, such as wired network interface 542 or wireless network interface 544. Computing device 500 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
sharing, by a first party computer program and a second party computer program, a set of identification keys, an authentication key, and a one-time pad (OTP) key;
selecting, by the first party computer program and the second party computer program, a first party key label or a second party key label;
preparing, by the second party computer program, quantum systems using a basis, randomly chosen bit values, and intensities;
sending, by the second party computer program, the quantum systems to the first party computer program over a quantum communication channel;
measuring, by the first party computer program, the quantum systems using the basis and announcing the quantum systems with detected photons;
generating, by the first party computer program, a first party tag using a shared keyed hash function executed on the authentication key, the OTP key, and the measured bit values from the quantum systems;
forwarding, by the first party computer system, the first party tag to the second party computer program;
validating, by the second party computer program, the first party using the first party tag;
generating, by the second party computer program, a second party tag using the shared keyed hash function executed on the authentication key, the OTP key, and the randomly chosen bit values from the quantum systems; and
validating, by the first party computer program, the second party using the second party tag.

2. The method of claim 1, wherein the second party computer program validates the first party by:
generating a first party validation tag using the shared keyed hash function executed on the authentication key, the OTP key, and measurement outcomes for the randomly chosen bit values; and
comparing the first party tag to the first party validation tag, wherein the first party is validated in response to the first party tag matching the first party validation tag.

3. The method of claim 1, wherein the basis is generated using a key expansion algorithm.

4. The method of claim 1, further comprising:
sharing, by the first party computer program and the second party computer program, a privacy amplification seed; and
performing, by the first party computer program with the second party computer program, privacy amplification to generate a shared secret bitstring and update the identification key associated with the selected key label.

5. The method of claim 4, further comprising:
selecting, by the first party computer program with the second party computer program, a new identification key in response to a failure.

6. The method of claim 2, wherein the measurement outcomes for the randomly chosen bit values are corrected using error correction to match the measurement outcomes.

7. The method of claim 6, further comprising:
sending, by the first party computer program a syndrome, wherein the second party computer program performs the error correction using the syndrome.

8. The method of claim 1, further comprising:
estimating, by the second party computer program, a number of multi-photon events in the quantum systems with photon detection based on the announcement of the quantum systems in a test set and an intensity for each of the quantum systems.

9. The method of claim 8, wherein the second party computer program declares failure in response to the number of multi-photon events in the quantum systems in a key generation set being above a threshold.

10. The method of claim 8, wherein the second party computer program selects the intensity using a random number generator.

11. A method for secure client authentication, comprising:
sharing, by a server computer program executed by a server and a client computer program for a client, a set of identification keys, and a one-time pad (OTP) key;
selecting, by the client computer program and the server computer program, a client key label or a server key label;
preparing, by the server computer program, quantum systems using a basis, randomly chosen bit values, and intensities;
sending, by the server computer program, the quantum systems to the client computer program over a quantum communication channel;
sending, by the server computer program, a server tag and a server key label to the client computer program;
measuring, by the client computer program, the quantum systems using the basis;
validating, by the client computer program, the server by comparing the server tag to a server tag generated by the client computer program in a prior interaction with the server;
generating, by the client computer program, a client tag using a shared keyed hash function executed on an authentication key and measured bit values from the quantum systems with photon detection;
receiving, by the server computer program, the client tag; and
validating, by the server computer program, the client using the client tag.

12. The method of claim 11, wherein the client computer program further validates the server by:
receiving, by the client computer program and from the server computer program, a server label and a server tag; and
comparing, by the client computer program, the server label and server tag received from the server computer program to a client label and a stored server label stored by the client computer program.

13. The method of claim 11, wherein the server computer program validates the client computer program by:
generating, by the server computer program, a client validation tag using the shared keyed hash function executed on the authentication key, the OTP key, and the randomly chosen bit values; and
comparing, by the server computer program, the client tag to the client validation tag, wherein the client is validated in response to the client tag matching the client validation tag.

14. The method of claim 11, further comprising:
sharing, by the client computer program and the server computer program, a privacy amplification seed; and
performing, by the server computer program and the client computer program, privacy amplification to update an identification key associated with the selected key label and generate server tags.

15. A method for secure client authentication, comprising:
sharing, by a server computer program and separately with a plurality of client computer programs, each client computer program associated with a client, sets of identification keys, a set of one-time pad (OTP) key, and an authentication key;
detecting, by the server computer program, a client electronic device executing the client computer program associated with one of the clients;
preparing, by the server computer program, a plurality of quantum system for the plurality of clients;
sending, by the server computer program, a server key label to the client computer program;
sending, by the server computer program, the plurality of quantum systems to the client computer program over a quantum communication channel;
measuring, by the client computer program, the quantum systems using a basis;
validating, by the client computer program, the server by comparing a server tag to a server tag generated by the client computer program in a prior interaction with the server;
generating, by the client computer program, a client tag using a shared keyed hash function executed on the authentication key, the OTP key, and measured bit values from the quantum systems with photon detection;
receiving, by the server computer program, the client tag and the client key label; and
validating, by the server computer program, the client using the client tag.

16. The method of claim 15, wherein the client computer program further validates the server by:
receiving, by the client computer program and from the server computer program, a server label and a server tag; and
comparing, by the client computer program, the server label and server tag received from the server computer program to a client label and a stored server label stored by the client computer program.

17. The method of claim 15, wherein the server computer program validates the client computer program by:
generating, by the server computer program, a client validation tag using the shared keyed hash function executed on the authentication key, the OTP key, and randomly chosen bit values; and
comparing, by the server computer program, the client tag to the client validation tag, wherein the client is validated in response to the client tag matching the client validation tag.

18. The method of claim 15, further comprising:
sharing, by the client computer program and the server computer program, a privacy amplification seed; and
performing, by the server computer program and the client computer program, privacy amplification to update the identification key associated with the key label and generate server tags.
